(19) United States
(12) Patent Application Publication
(10) Pub. No.: US 2010/0309975 A1
(43) Pub. Date: Dec. 9, 2010

(54) IMAGE ACQUISITION AND TRANSCODING SYSTEM

(75) Inventors: Xiaosong ZHOU, Campbell, CA (US); Davide CONCION, San Jose, CA (US); Guy COTE, San Jose, CA (US); Cecile FORET, Palo Alto, CA (US); Haitao (Harry) GUO, San Jose, CA (US); Ionut HRISTODORESCU, San Jose, CA (US); James Oliver NORMILE, Los Altos, CA (US); Xiaojin SHI, Fremont, CA (US); Hsi-Jung WU, San Jose, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/533,985

(22) Filed: Jul. 31, 2009

Related U.S. Application Data
(60) Provisional application No. 61/184,780, filed on Jun. 5, 2009.

(51) Int. Cl. H04N 7/26

(52) U.S. Cl. 375/240.03; 375/240.01; 375/E07.139

(57) ABSTRACT

A method and system are provided to encode a video sequence into a compressed bitstream. An encoder receives a video sequence from an image-capture device, together with metadata associated with the video sequence, and codes the video sequence into a first compressed bitstream using the metadata to select or revise a coding parameter associated with a coding operation. Optionally, the video sequence may be conditioned for coding by a preprocessor, which also may use the metadata to select or revise a preprocessing parameter associated with a preprocessing operation. The encoder may itself generate metadata associated with the first compressed bitstream, which may be used together with any metadata received by the encoder, to transcode the first compressed bitstream into a second compressed bitstream. The compressed bitstreams may be decoded by a decoder to generate recovered video data, and the recovered video data may be conditioned for viewing by a postprocessor, which may use the metadata to select or revise a postprocessing parameter associated with a postprocessing operation.

### CROSS-REFERENCE TO RELATED APPLICATIONS

The present application claims the benefit of U.S. Provisional application, Ser. No. 61/184,780 filed Jun. 5, 2009, entitled “IMAGE ACQUISITION AND ENCODING SYSTEM.” The present application also is related by common inventorship and subject matter to co-filed and co-pending U.S. Non-Provisional application, Ser. No. 12/533,927, filed Jul. 31, 2009, entitled “IMAGE ACQUISITION AND ENCODING SYSTEM.” The aforementioned applications are incorporated herein by reference in their entirety.

### BACKGROUND

With respect to encoding and compression of video data, it is known that encoders generally rely only on information they can cull from an input stream of images (or, in the case of a transcoder, a compressed bitstream) to inform the various processes (e.g., frame-type determination) and devices (e.g., a rate controller) that may constitute operation of a video encoder. This information can be computationally expensive to derive, and may fail to provide the video encoder with cues it may need to generate an optimal encode in an efficient manner.

### BRIEF DESCRIPTION OF THE DRAWINGS

FIG. 1 illustrates a coder-decoder system according to an embodiment.

FIG. 2 is a simplified diagram of an encoder and a rate controller according to an embodiment.

FIG. 3 is a simplified diagram of a preprocessor according to an embodiment.

FIG. 4 illustrates generally a method of encoding a video sequence according to an embodiment.

FIG. 5 illustrates generally a method for determining whether to modify quantization parameters based on motion according to an embodiment.

FIG. 6 illustrates exemplary fluctuation of brightness over successive frames according to an embodiment.

FIG. 7 illustrates generally a method of using brightness metadata to modify quantization parameters according to an embodiment.

FIG. 8 illustrates a system for transcoding video data according to an embodiment.

FIG. 9 illustrates generally a method of transcoding video data according to an embodiment.

FIG. 10 illustrates generally various methods of making coding decisions at a transcoder according to an embodiment.

### DETAILED DESCRIPTION

Embodiments of the present invention can use measurements and/or statistics metadata provided by an image-capture system to supplement selection or revision of coding parameters by an encoder. An encoder can receive a video sequence together with associated metadata and may code the video sequence into a compressed bitstream. The coding process may include initial parameter selections made according to a coding policy, and revision of a parameter selection according to the metadata. In some embodiments, various coding decisions and information associated with the compressed bitstream may be passed to a transcoder, which may use the coding decisions and other information, in addition to the metadata originally provided by the image-capture system to supplement decisions associated with transcoding operations. The scheme may reduce the complexity of the generated bitstream(s) and increase the efficiency of the coding process(es) while maintaining perceived quality of the video sequence when recovered at a decoder. Thus, the bitstream(s) may be transmitted with less bandwidth, and the computational burden on both the encoder and decoder may be lessened.

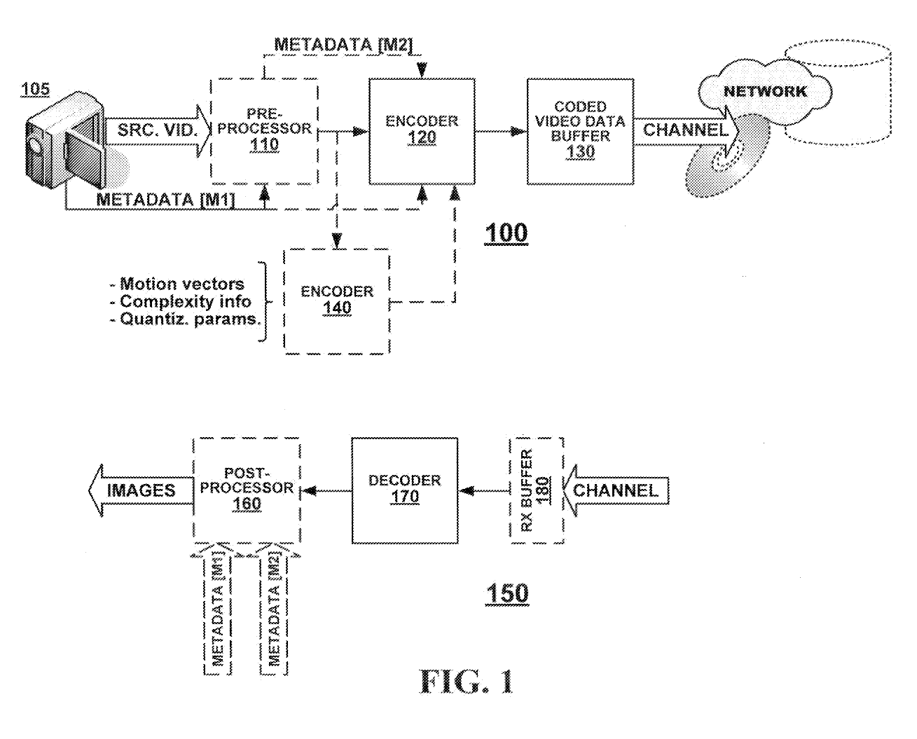

FIG. 1 illustrates a system 100 for encoding and a system 150 for decoding according to an embodiment. Various elements of the systems (e.g., encoder 120, preprocessor 110, etc.) may be implemented in hardware or software. The camera 105 may be an image-capture device, such as a video camera, and may comprise one or more metadata sensors to provide information regarding the captured video or circumstances surrounding the capture, including certain in-camera values used and/or calculated by the camera 105 (e.g., exposure time, aperture, etc.). The metadata M1 need not be generated solely by the camera device itself. To that end, a metadata sensor may be provided ancillary to the camera 105 to provide, for example, spatial information regarding orientation of the camera. Metadata sensors may include, for example, accelerometers, gyroscopic sensors, GPS units and similar devices. Control units (not shown) may merge the output from such metadata sensors into the metadata data stream M1 in a manner that associates the output with the specific portions of the video sequences to which they relate. The camera 105 and any metadata sensors may together be considered an image-capture system.

The preprocessor 110 (as shown in phantom) optionally receives the metadata M1 from metadata sensor(s) 110 and images (i.e., the video sequence) from the camera 105. The preprocessor 110 may preprocess the set of images using the metadata Ml prior to coding. The preprocessed images may form a preprocessed video sequence that may be received by the encoder 120. The preprocessor 110 also may generate a second set of metadata M2, which may be provided to the encoder 120 to supplement selection or revision of a coding parameter associated with a coding operation.

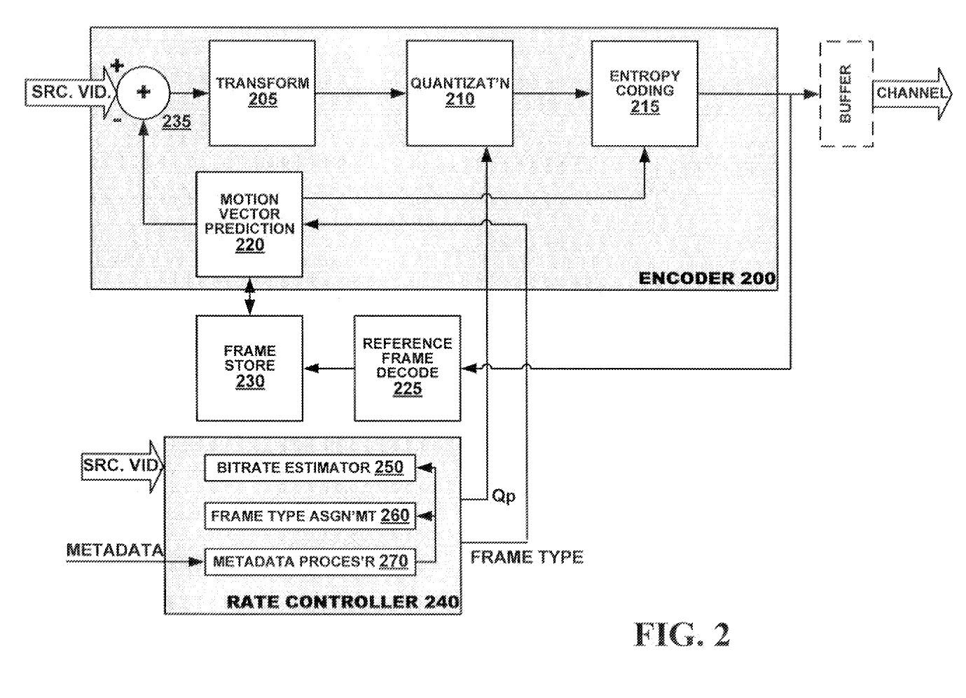

The encoder 120 may receive as its input the video sequence from the camera 105 or the preprocessed video sequence if the preprocessor 110 is used. The encoder 120 may code the input video sequence as coded data according to a coding process. Typically, such coding exploits spatial and/or temporal redundancy in the input video sequence and generates coded video data that is bandwidth-compressed as compared to the input video sequence. Such coding further involves selection of coding parameters, such as quantization parameters and the like, which are transmitted in a channel as part of the coded video data and are used during decoding to recover a recovered video sequence. The encoder 120 may receive the metadata M1, M2 and may select coding parameters based, at least in part, on the metadata. It will be appreciated that typically an encoder works together with a rate controller to make various coding decisions, as is shown in FIG. 2 and detailed below.

The coded video data buffer 130 may store the coded bitstream before transferring it to a channel, a transmission medium to carry the coded bitstream to a decoder. Channels typically include storage devices such as optical, magnetic or electrical memories and communications channels provided, for example, by communications networks or computer networks.

In an embodiment, the encoding system 100 may include a pair of pipelined encoders 120, 140 (as shown in FIG. 1). The first encoder of the pipeline (encoder 140 in the embodiment of FIG. 1) may perform a first coding of the source video and the second encoder (encoder 120 as illustrated) may perform a second coding. Generally, the first encoding may attempt to code the source video and satisfy one or more target constraints (for example, a target bitrate) without having first examined the source video data and determined the complexity of the image content therein. The first encoder 140 may generate metadata representing the image content, including motion vectors, quantization parameters, temporal or spatial complexity estimates, etc. The second encoder 120 may refine the coding parameters selected by the first encoder 140 and may generate the final coded video data. The first and second encoders 120, 140 may operate in a pipelined fashion; for example, the second encoder 120 may operate a predetermined number of frames behind the first encoder 140.

The encoding operations carried out by the encoding system 100 may be reversed by the decoding system 150, which may include a receive buffer 180, a decoder 170 and a postprocessor 160. Each unit may perform the inverse of its counterpart in the encoding system 100, ultimately approximating the video sequence received from the camera 105. The postprocessor 160 may receive the metadata M1 and/or the metadata M2, and use this information to select or revise a postprocessing parameter associated with a postprocessing operation (as detailed below). The decoder 170 and the postprocessor 160 may include other blocks (not shown) that perform various processes to match or approximate coding processes applied at the encoding system 100.

FIG. 2 is a simplified diagram of an encoder 200 and a rate controller 240 according to an embodiment. The encoder 200 may include a transform unit 205, a quantization unit 210, an entropy coding unit 215, a motion vector prediction unit 220, and a subtractor 235. A frame store 230 may store decoded reference frames (225) from which prediction references may be made. If a pixel block is coded according to a predictive coding technique, the prediction unit 220 may retrieve a pixel block from the frame store 230 and output it to the subtractor 235. Motion vectors represent the prediction reference made between the current pixel block and the pixel block of the reference frame. The subtractor 235 may generate a block of residual pixels representing the difference between the source pixel block and the predicted pixel block. The transform unit 205 may convert a pixel block's residuals into an array of transform coefficients, for example, by a discrete cosine transform (DCT) process or wavelet process. The quantization unit 210 may divide the transform coefficients by a quantization parameter. The entropy coding unit 215 may code the truncated coefficients and motion vectors received from the prediction unit 220 by run-value, run-length or similar coding for compression. Thereafter, the coded pixel block coefficients and motion vectors may be stored in a transmission buffer until they are to be transmitted to the channel.

The rate controller 240 may be used to manage the bit budget of the bitstream, for example, by keeping the number of bits available per frame under a prescribed, though possibly varying threshold. To this end, the rate controller 240 may make coding parameter assignments by, for example, assigning prediction modes for frames and/or assigning quantization parameters for pixel blocks within frames. The rate controller 240 may include a bitrate estimation unit 250, a frame-type assignment unit 260 and a metadata processing unit 270. The bitrate estimation unit 250 may estimate the number of bits needed to encode a particular frame at a particular quality, and the frame-type assignment unit 260 may determine what prediction type (e.g., I, P, B, etc.) should be assigned to each frame.

The metadata processor 270 may receive the metadata M1 associated with each frame, analyze it, and then may send the information to the bitrate estimation unit 250 or frame-type assignment unit 260, where it may alter quantization parameter or frame-type assignments. The rate controller 240, and more specifically, the metadata processor 270 may analyze metadata one frame at a time or, alternatively, may analyze metadata for a plurality of contiguous frames in an effort to detect a pattern, etc. Similarly, the rate controller 240 may contain a cache (not shown) for holding in memory various metadata values so that they can be compared relative to each other. As is known, various compression processes base their selection of coding parameters on other inputs and, therefore, the rate controller 240 may receive inputs and generate outputs other than those shown in FIG. 2.

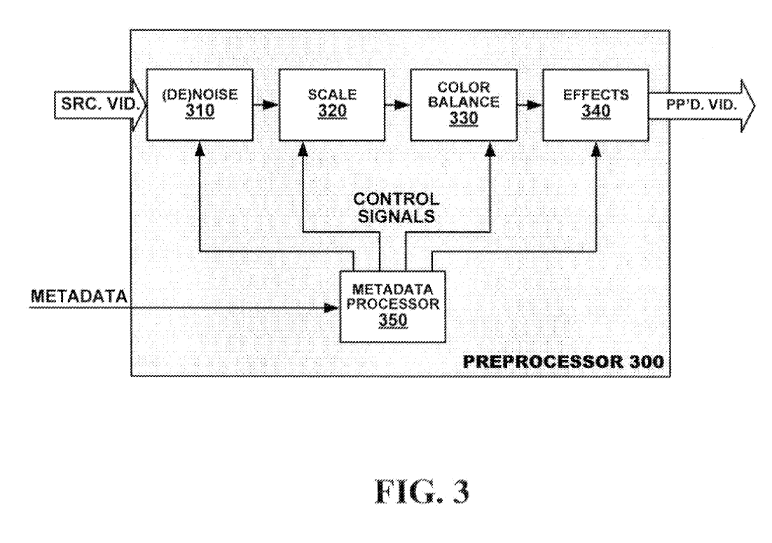

FIG. 3 is a simplified diagram of a preprocessor 300 according to an embodiment of the present invention. Preprocessor 110 may include a noise/denoise unit 310, a scale unit 320, a color balance unit 330, an effects unit 340, and a metadata processor 350. Generally, the preprocessor 300 may receive the source video and the metadata M1, and the metadata processor 350 may control operation of units 310, 320, 330 and 340. Control signals sent from the metadata processor 350 to each of the units 310, 320, 330 and 340 may include information regarding various aspects of the particular preprocessing operation (as described in more detail below), such as, for example, the strength of a denoising filter.

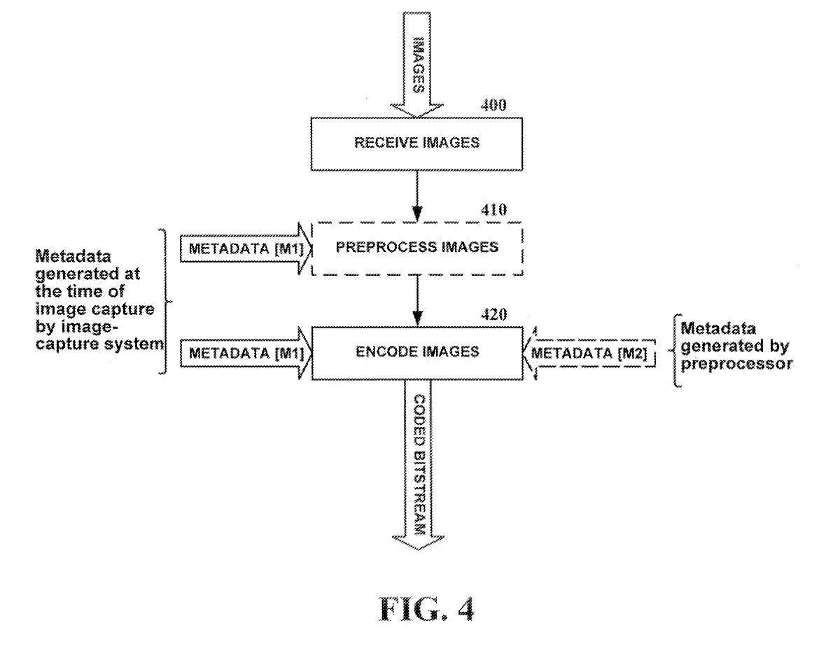

FIG. 4 illustrates generally a method of encoding a video sequence according to an embodiment. Throughout the discussion of FIG. 4, various examples are provided with respect to the stages of the method (e.g., preprocessing, encoding, etc.). At block 400, the method may receive a video sequence (i.e., a set of images) from an image-capture device (e.g., a video camera, etc.). Together with the video sequence, additional data (metadata M1) associated with the video sequence also may be received and may indicate circumstances surrounding the capture (e.g., stable or non-stable environment), the white balance of certain portions of the video sequence, what parts of the video sequence are in focus relative to other parts, etc.

The metadata M1 may be generated by the image-capture device or an apparatus external to the image-capture device, such as, for example, a boom arm on which the image-capture device is mounted. When the metadata M1 is generated by the image-capture device, it may be calculated or derived by the device or come from the device's image sensor processor (ISP). For each image in the video sequence, the metadata M1 may include, for example, exposure time (i.e., a measure of the amount of light allowed to hit the image sensor), digital/analog gain (generally an indication of noise level, which may comprise an exposure value plus an amplification value), aperture value (which generally determines the amount and angle of light allowed to hit the image sensor), luminance (which is a measure of the intensity of the light hitting the image sensor and which may correspond to the perceived brightness of the image/scene), ISO (which is a measure of the image sensor's sensitivity to light), white balance (which generally is an adjustment used to ensure neutral colors remain neutral), focus information (which describes whether the light from the object being filmed is well-converged; more generally, it is the portion of the image that appears sharp to the eye), brightness, physical motion of the image-capture device (via, for example, an accelerometer), etc.

Additionally, certain metadata may be considered singly or in combination with other metadata. For example, exposure time, digital/analog gain, aperture value, luminance, and ISO may be considered as a single value or score in determining the parameters to be used by certain preprocessing or encoding operations.

At block 410, one or more of the images optionally may be preprocessed (as shown in phantom), wherein the video sequence may be converted into a preprocessed video sequence. “Preprocessing” refers generally to operations that condition pixels for video coding, such as, for example, denoising, scaling, color balancing, effects, packaging each frame into pixelblocks or macroblocks, etc. As at block 420—where the video sequence is encoded—the preprocessing stage may take into account received metadata M1. More specifically, a preprocessing parameter associated with a preprocessing operation may be selected or revised according to the metadata associated with the video sequence.

As an example of preprocessing according to the metadata M1, consider denoising. Generally, denoising filters attempt to remove noise artifacts from source video sequences prior to the video sequences being coded. Noise artifacts typically appear in source video as small aberrations in the video signal within a short time duration (perhaps a single pixel in a single frame). Denoising filters can be controlled during operation by varying the strength of the filter as it is applied to video data. When the filter is applied at a relatively low level of strength (i.e., the filter is considered “weak”), the filter tends to allow a greater percentage of noise artifacts to propagate through the filter uncorrected than when the filter is applied at a relatively high level of strength (i.e., when the filter is “strong”). A relatively strong denoising filter, however, can induce image artifacts for portions of a video sequence that do not include noise.

According to an embodiment of the invention, the value of a preprocessing parameter associated with the strength of a denoising filter can be determined by the metadata M1. For example, the luminance and/or ISO values of an image may be used to control the strength of the denoising filter; in low-light conditions, the strength of the denoising filter may be increased relative to the strength of the denoising filter in bright conditions.

The denoiser may be a temporal denoiser, which may generate an estimate of global motion within a frame (i.e., the sum of absolute differences) that may be used to affect future coding operations; also, the combination of exposure and gain metadata M1 may be used to determine a noise estimate for the image, which noise estimate may affect operation of the temporal denoiser. At least one benefit of using such metadata to control the strength of the denoising filter is that it may provide more effective noise elimination, which can improve coding efficiency by eliminating high-frequency image components while at the same time maintaining appropriate image quality.

As another example of preprocessing according to the metadata M1, consider scaling of the video sequence. As is well known, scaling is the process of converting a first image/video representation at a first resolution into a second image/video representation at a second resolution. For example, a user may want to convert high-definition (HD) video captured by his camera into a VGA (640×480) version of the video.

When scaling there inherently are choices as to which scaling filters (and associated parameters) to use. Scaling generally implies that there is a relatively high level of high-frequency information in the image, which can affect these filters and parameters. Various metadata M1 (e.g., focus information) can be used to select a preprocessing parameter associated with a filter operation. Similarly, if in-device scaling occurs (via, e.g., binning, line-skipping, etc.), such information can be used by the pre/postprocessor. In-device scaling may insert artifacts into the image, which artifacts may be searched for by the preprocessor (via, e.g., edge detection), and the size, frequency, etc. of the artifacts may be used to determine which scaling filters and coefficients to use, as may the knowledge of the type of scaling performed (e.g., if it is known that the image was not binned, only line-skipped, then a relatively heavy filter may be used to compensate for any aliasing artifacts).

Preprocessing may be used to decrease coding complexity at the encoding stage. For example, if the dynamic range of the video sequence (or, rather, the images comprising the video sequence) is known, then it can be reduced during the preprocessing stage such that the encoding process is easier. Additionally, the preprocessing stage itself may generate metadata M2 which may be used by the encoder (or a decoder, transcoder, etc., as discussed below), in which case the metadata M2 generated by the preprocessing stage may be multiplexed with the metadata M1 received with the original video sequence or it can be stored/received separately.

Generally, increasing brightness is a difficult situation to code for, and an image-capture device may artificially attempt to normalize brightness (i.e., keep it within a predetermined range) by, for example, modifying the aperture of the optics system and the integration time of the image sensor. However, during dynamic changes, the aperture/integration control may lag behind the image sensor. In such a situation, if, for example, the metadata M1 indicates that the image-capture device is relatively still over the respective frames, and the only thing that really is changing is the aperture/integration controls as the camera attempts to adjust to the new steady-state operational parameters, then a preprocessor may attempt to further normalize brightness across the respective frames.

At block 420, an encoder may code the input video sequence into a coded bitstream according to a video coding policy. At least one of the coding parameters that make up the video coding policy may be selected or revised according to the metadata, which may include the metadata M2 generated at the preprocessing stage (as shown in phantom), and the metadata M1 associated with the original video sequence. Examples of the parameters whose values may be selected or revised by the metadata include bitrates, frame types, quantization parameters, etc.

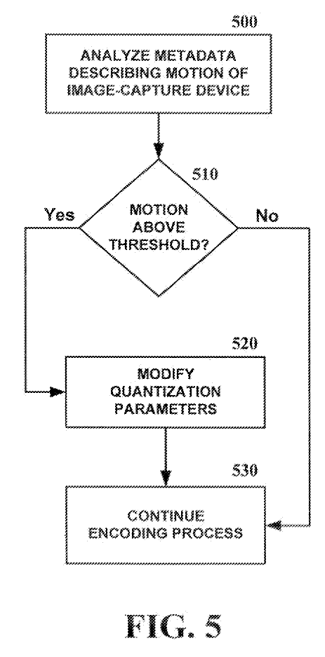

As an example of how the coding at block 420 may use the metadata M1 to select certain of its parameters, consider metadata M1 describing motion of the image-capture device, which can be used, for example, to select quantization parameters and/or bitrates for various portions of the video sequence. FIG. 5 illustrates generally a method for determining whether to modify quantization parameters based on motion according to an embodiment. In an embodiment, quantization parameters can be increased for portions of a video sequence for which the camera was moving as compared to other portions of a video sequence for which the camera was not moving (block 500). If, for example, the motion is above a pre-defined threshold (e.g., constant acceleration over 30 frames, etc.), then a rate controller may increase the quantization parameters for the frames associated with the motion (blocks 510 and 520). If the motion is determined to be below the threshold, then the quantization parameters for these particular frames may not be affected by the motion metadata (block 530). Similarly, a target bitrate generally can be decreased for portions of a video sequence for which the camera was moving as compared to other portions for which the camera was not moving.

In both cases, a moving camera likely is to acquire video sequences with a relatively high proportion of blurred image content due to the motion. Use of relatively high quantization parameters and/or low target bitrates likely will cause the respective portion to be coded at a lower quality than for other portions where a quantization parameter is lower or a target bitrate is higher. This coding policy may induce a higher number of coding errors into the “moving” portion, but the errors may not affect perceptual quality due to blurred image content in the source image(s).

As another example of how coding parameters may be adjusted according to the metadata, consider metadata M1 that describes focus information, which may indicate that the camera actually is in the act of focusing over a plurality of frames. In this case, and generally without sacrificing perceptual quality, the encoder may encode with less quality/bandwidth the frames occurring during the “unfocused” phase than those occurring where focus has been set or “locked,” and may adjust quantization parameters, etc., accordingly.

A rate controller may select coding parameters based on a focus score delivered by the camera. The focus score may be provided directly by the camera as a pre-calculated value or, alternatively, may be derived by the rate controller from a plurality of values provided by the camera, such as, for example, aperture settings, the focal length of the image-capture device's lens, etc. A low focus score may indicate that image content is unfocused, but a higher focus score may indicate that image content is in focus. When the focus score is low, the rate controller may increase quantization parameters over default values provided by a default coding scheme. As discussed, higher quantization parameters provide generally greater compression, but they can lower perceived quality of a recovered video sequence. However, for video sequences with low focus scores, reduced quality may not be as perceptible because the image content is unfocused.

As another example, changes in exposure can be used to, for example, select or revise parameters associated with the allocation of intra/inter-coding modes or the quantization step size. By analyzing certain of the metadata M1 (e.g., exposure, aperture, brightness, etc.) during the coding stage, particular effects may be detected, such as an exposure transition, or fade (e.g., when a portion of the video sequence moves from the ground to the sky). Given this information, a rate controller may, for example, determine where in a fade-like sequence a new I-frame will be used (e.g., at the first frame whose exposure value is halfway between the exposure values of the first and last frames in the fade-like sequence).

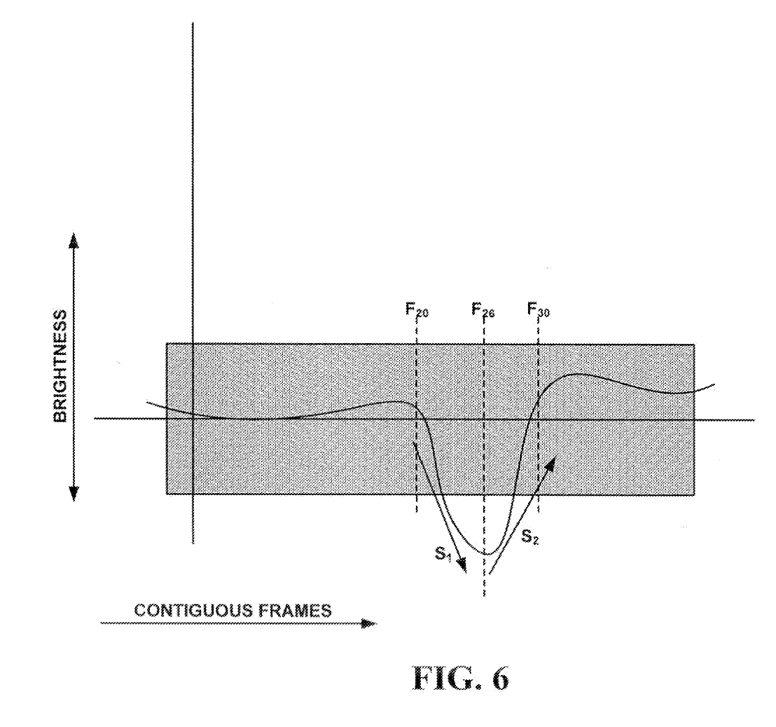

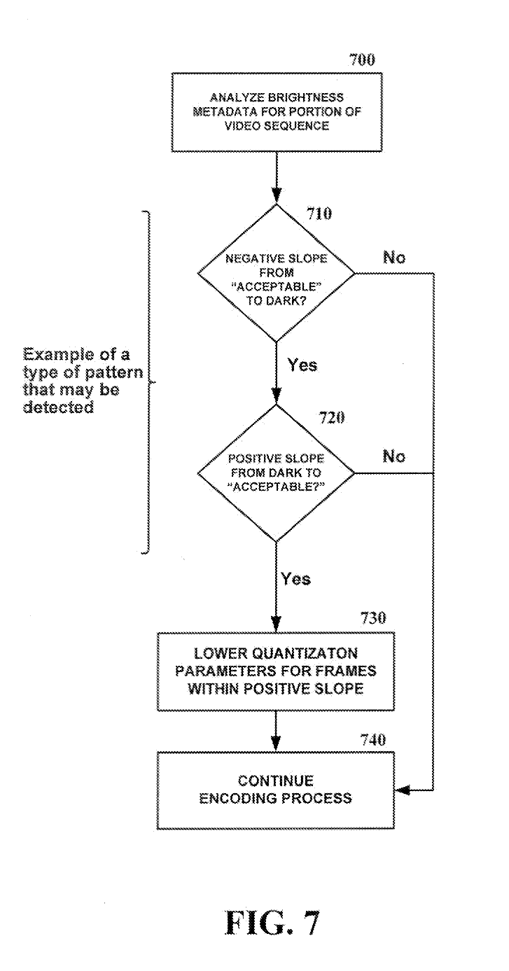

As discussed, exposure metadata may include indicators of the brightness, or luma, of each image. Generally, a camera's ISP will attempt to maintain the brightness at a constant level within upper and lower thresholds (labeled “acceptable” levels herein) so that the perceived quality of the images is reasonable, but this does not always work (e.g., when the camera is moving too quickly from shooting a very dark scene to shooting a very bright scene). By analyzing brightness metadata associated with some number of contiguous frames, a rate controller may determine a pattern (see, e.g., FIGS. 6 and 7), and may alter, for example, quantization parameters accordingly, so as to minimize the risk of blocking artifacts in the encoded image while at the same time using as few bits as possible.

FIG. 6 illustrates exemplary fluctuation of brightness over successive frames according to an embodiment, and FIG. 7 illustrates generally a method of using brightness metadata M1 to affect the value of quantization parameters according to an embodiment. Analyzing the frames (block 700) from left to right (i.e., forward in time), the brightness of the frames remains relatively constant and within a predefined range of “acceptability” (as depicted by the shaded rectangle). However, between frame 20 (F₂₀) and frame 26 (F₂₆) the brightness of the frames decreases significantly and eventually goes below the “acceptable” range, as characterized by negative slope 1 (S₁). After frame 26, the brightness of the frames begins to increase sharply, as characterized by positive slope 2 (S₂), and it is within these frames where blocking artifacts are most likely to occur. After detecting, for example, this particular dual-slope pattern (blocks 710 and 720), a rate controller may do nothing with respect to slope S₁ (blocks 710 and 740), but may lower the quantization parameters used for frames comprising slope S₂ (block 730) in an effort to minimize potential blocking artifacts in the bitstream.

Together with the direction (i.e., light-to-dark, dark-to-light, etc.) of the brightness gradient over contiguous frames, a rate controller also may take into account various other metadata M1, such as, for example, movement of the camera. For example, if, over a number of successive frames, the brightness and camera motion are above or increasing beyond predetermined thresholds, then quantization parameters may be increased over the frames. The alteration of quantization parameters in this exemplary instance may be acceptable because it is likely that the image is 1) washed-out and 2) blurry; thus, the perceived quality of the encoded image likely will not suffer from a fewer number of bits being allocated to it.

A rate controller also may use brightness to supplement frame-type decisions. Generally, frame types may be assigned according to a default group of frames (GOP) (e.g., I, B, B, B, P, I); in an embodiment, the GOP may be modified by information from the metadata M1 regarding brightness. For example, if, between two successive frames, the change in brightness is above a predetermined threshold, and the number of macroblocks in the first frame to be intra-coded is above a predetermined threshold (e.g., 70%), then the rate controller may “force” the first frame to be an I-frame even though some of its macroblocks may otherwise have been inter-coded.

Similarly, metadata M1 for a few buffered frames may be used to determine, for example, the amount by which a camera's auto-exposure adjustment is lagging behind; this measurement can be used to either preprocess the frames to correct the exposure, or indicate to the encoder certain characteristics of the incoming frames (i.e., that the frames are under/over-exposed) so that, for example, a rate controller can adjust various parameters accordingly (e.g., lower the bitrate, lower the frame rate, etc.).

As still another example, white balance adjustments/information from the camera may be used by the encoder to detect, for example, scene changes, which can help the encoder to allocate bits appropriately, determine when a new I-frame should be used, etc. For example, if the white balance adjustment for each of frames 10-30 remains relatively constant, but at frame 31 the adjustment changes dramatically, then that may be an indication that, for example, there has been a scene change, and so the rate controller may make frame 31 an I-frame.

Like preprocessing and encoding, “postprocessing” also may take advantage of metadata associated with the original video sequence and/or the preprocessed video sequence. Once the coded bitstream has been decoded by a decoder into a video sequence, the video sequence optionally may be postprocessed by a postprocessor using the metadata. Postprocessing refers generally to operations that condition pixels for viewing. According to an embodiment, a postprocessing stage may perform such operations using metadata to improve them.

Many of the operations done in the preprocessing stage may be augmented or reversed in the postprocessing stage using the metadata M1 generated during image-capture and/or the metadata M2 generated during preprocessing. For example, if denoising is done at the preprocessing stage (as discussed above), information pertaining to the type and amount of denoising done can be passed to the postprocessing stage (as additional metadata M2) so that the noise can be added back to the image. Similarly, if the dynamic range of the images was reduced during preprocessing (as discussed above), then on the decode side the inverse can be done to bring the dynamic range back to where it was originally.

As another example, consider the case where the postprocessor has information from the preprocessor regarding how the image was downscaled, what filter coefficients were used, etc. In such a case, that information can be used by the postprocessor to compensate for image degradation possibly introduced by the scaling. Generally, preprocessing generates artifacts in the video, but by using metadata associated with the original video sequence and/or preprocessing operations, decoding operations can be told where/what these artifacts are and can attempt to correct them.

Postprocessing operations may be performed using metadata associated with the original video sequence (i.e., the metadata M1). For example, a postprocessor may use white balance values from the image-capture device to select postprocessing parameters associated with the color saturation and/or color balance of a decoded video sequence. Thus, many of the metadata-using processing operations described herein can be performed either in the preprocessing stage or the postprocessing stage, or both.

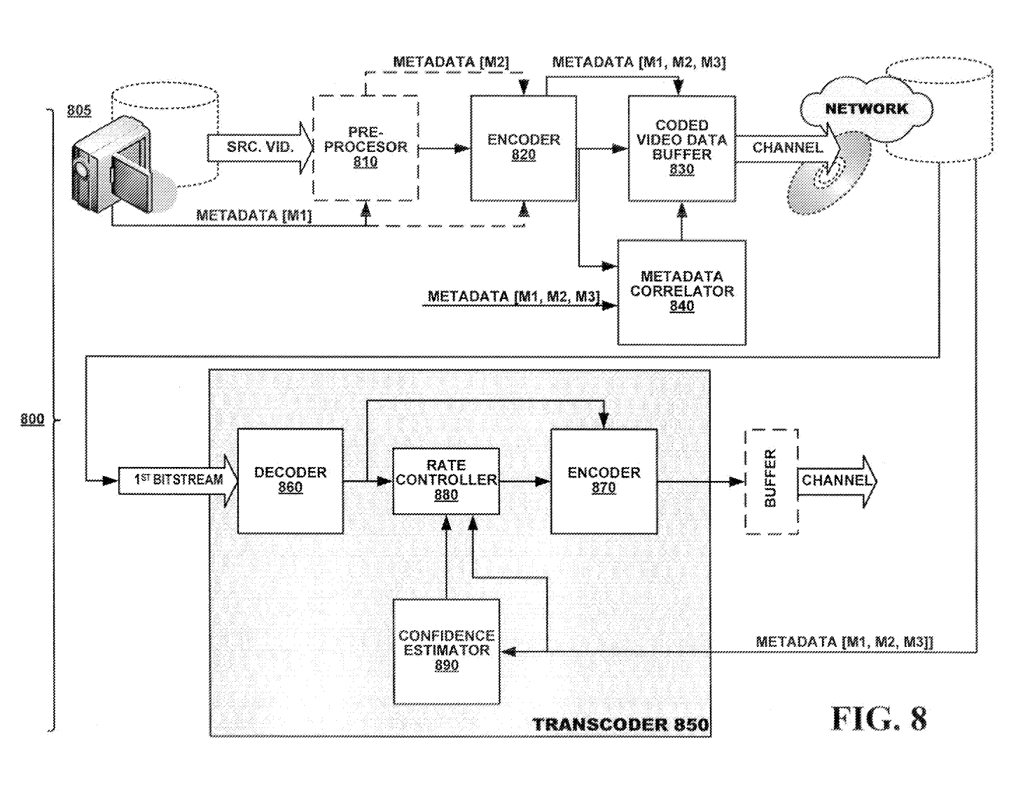

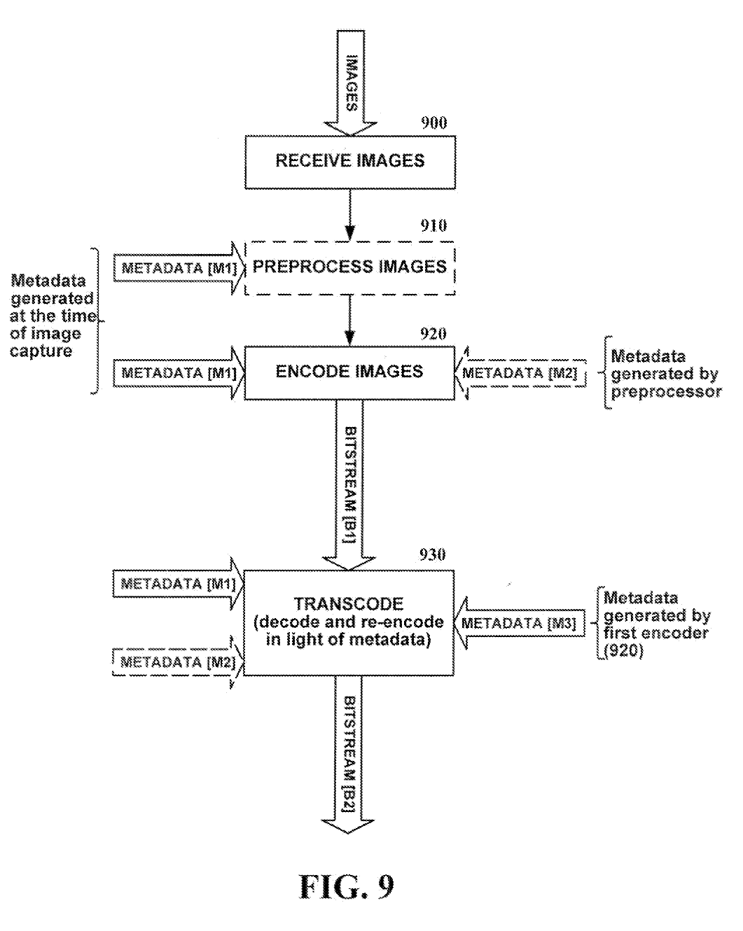

FIG. 8 illustrates a coding system 800 for transcoding video data according to an embodiment. FIG. 9 illustrates generally a method of transcoding video data according to an embodiment and is referenced throughout the discussion of FIG. 8. The system may include a camera 805 to capture source video, a preprocessor 810 and a first encoder 820. The camera 805 may output source video data to the preprocessor and also a first set of metadata M1 that may identify, for example, camera operating conditions at the time of capture. The preprocessor 810 may perform processing operations on the source video to condition it for processing by the encoder 820 (block 910 of FIG. 9). The preprocessor 810 may generate its own set of metadata identifying characteristics of the source video data that were generated as the preprocessor 810 performed its operations. For example, a temporal denoiser may generate data identifying motion of image content among adjacent frames. The first encoder 820 may compress the source video into coded video data and may generate a third set of metadata M3 identifying its coding processes (block 920 of FIG. 9). Coded video data and metadata may be buffered 830 before being transmitted from the encoder 820 via a channel. It will be appreciated that metadata can be transported between the encoder 820 and the transcoder 850 in any of several different ways, including, but not limited to, within the bitstream itself, via another medium (e.g., bitstream SEI, a separate track, another file, other out-of-band channels, etc.), or some combination thereof.

It will be appreciated that during encoding of the first bitstream, certain frames may be dropped, averaged, etc., potentially causing metadata to become out of sync with the frame(s) it purports to describe. Further, certain metadata may not be specific to a single frame, but may indicate a difference of a certain metric (e.g., brightness) between two or more frames. In light of these issues, the encoder 820 may include a metadata correlator 840 to map the metadata to the first bitstream (using, for example, time stamps, key frames, etc.) such that if the first bitstream is decoded by a transcoder, any metadata will be associated with the portion of the recovered video to which it belongs. The syncing information may be multiplexed together with the metadata or kept separate from it.

The coding system 800 further may include a transcoder 850 to recode the coded video data according to a second coding protocol (block 930 of FIG. 9). For the purposes of the present discussion, it is assumed that coding system 800 discards the source video at some time before operation of the transcoder 850, however, it is not required the coding system 800 do so in all cases. The transcoder 850 may include a decoder 860 to generate recovered video data from the coded video data generated by the first encoder 830 and a second encoder 870 to recode the recovered video data according to a second coding protocol. The transcoder 850 further may include a rate controller 880 that controls operation of the second encoder 870 by, for example, selecting coding parameters that govern the second encoder's operation. Though not shown, the rate controller may include a metadata processor, bitrate estimator or frame type assigner, as described previously with regard to FIG. 2. The rate controller 880 may select coding parameters based on the metadata M1, M2 obtained by the camera 805 or the preprocessor 810 according to the techniques presented above.

The rate controller 880 further may select coding parameters based on the metadata M3 obtained by the first encoder 820. The metadata M3 may include information defining or indicating (Qₚ,bits) pairs, motion vectors, frame or sequence complexity (including temporal and spatial complexity), bit allocations per frame, etc. The metadata M3 also may include various candidate frames that the first encoding process held onto before making final decisions regarding which of the candidate frames would ultimately be used as reference frames, and information regarding intra/inter-coding mode decisions.

Additionally, the metadata M3 also may include a quality metric that may indicate to the transcoder the objective and/or perceived quality of the first bitstream. A quality metric may be based on various known objective video evaluation techniques that generally compare the source video sequence to the compressed bitstream, such as, for example, peak signal-to-noise ratio (PSNR), structural similarity index (SSIM), video quality metric (VQM), etc. A transcoder may use or not use certain metadata based on a received quality metric. For example, if the quality metric indicates that a portion of the first bitstream is of excellent quality (either relative to other portions of the first bitstream, or absolutely with respect to, for example, the compression format of the first bitstream), then the transcoder may re-use certain metadata associated with coding parameters for that portion of the sequence (e.g., quantization parameters, bit allocations, frame types, etc.) instead of expending processing time and effort calculating those values again.

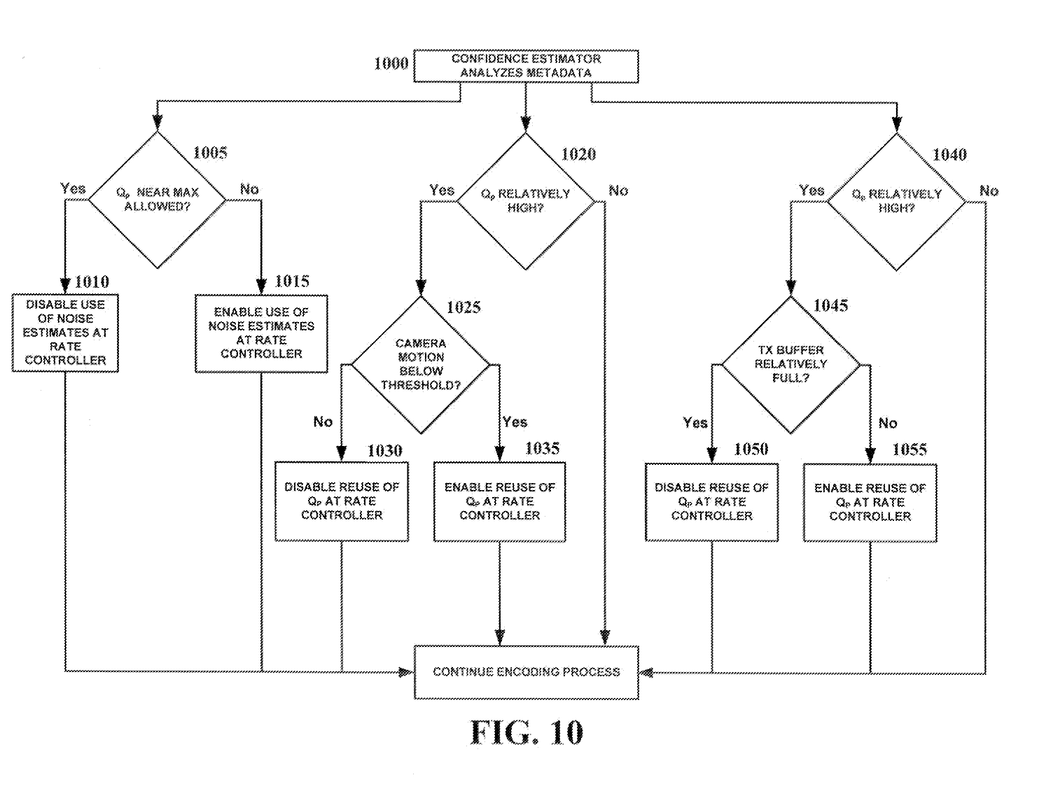

In an embodiment, the transcoder 850 may include a confidence estimator 890 that may adjust the rate controller's reliance on the metadata M1, M2, M3 obtained by the first coding operation. FIG. 10 illustrates generally various methods of using the confidence estimator 890 to supplement coding decisions at encoder 870, and will be referenced throughout certain of the examples discussed below.

In an embodiment, the confidence estimator 890 may examine a first set of metadata to determine whether the rate controller may consider other metadata to set coding parameters (block 1000 of FIG. 10). For example, the confidence estimator 890 may review quantization parameters from the coded video data (metadata M3) to determine whether the rate controller 880 is to factor camera metadata M1 or preprocessor metadata M2 into its calculus of coding parameters. For example, when a quantization parameter is set near or equal to the maximum level permitted by the particular codec (block 1005 of FIG. 10), the confidence estimator 890 may disable the rate controller 880 from using noise estimates generated by the camera or the preprocessor in selecting a quantization parameter for a second encoder (block 1010 of FIG. 10). Conversely, if a quantization parameter is well below the maximum level permissible, the confidence estimator 890 may enable the rate controller 890 to use noise estimates in its calculus (block 1015 of FIG. 10).

In another embodiment, the confidence estimator 890 may review camera metadata to determine whether the rate controller 880 may rely on or re-use quantization parameters from the first coding in the second coding. For example, if the confidence estimator 890 encounters coded video data with a relatively high quantization parameter (block 1020 of FIG. 10), and camera metadata M1 indicates a relatively low level of camera motion (block 1025 of FIG. 10), then confidence estimator 890 may enable the rate controller 880 to re-use the quantization parameter (block 1035 of FIG. 10). Conversely, if the camera metadata indicates a high level of motion, the confidence estimator 890 may disable the rate controller from re-using the quantization parameter from the first encoding (block 1030 of FIG. 10). The rate controller 880 would be free to select quantization parameters based on its default operating policies and, as described above, based on other metadata M1, M2 available in the system.

In a further embodiment, the confidence estimator 890 may review encoder metadata M3 to determine whether the rate controller 880 may rely on or re-use quantization parameters from the first encoding in the second coding. For example, if the confidence estimator 890 encounters coded video data with a relatively high quantization parameter (block 1040 of FIG. 10), and metadata M3 indicates that a transmit buffer is relatively full (block 1045 of FIG. 10), then confidence estimator 890 may modulate the rate controller's reliance on the first quantization parameter. Metadata M3 that indicates a relatively full transmit buffer may cause the confidence estimator 890 to disable the rate controller 880 from reusing the quantization parameter from the first encoding (block 1050 of FIG. 10). The rate controller 880 would be free to select quantization parameters based on its default operating policies and, as described above, based on other metadata M1, M2 available in the system. However, metadata that indicates that a transmit buffer was not full when a quantization parameter was selected may cause the confidence estimator 890 to allow the rate controller 870 to reuse the quantization parameter (block 1055 of FIG. 10).

Coding system 800 may include a preprocessor (not shown) to condition pixels for encoding by encoder 870, and certain preprocessing operations may be affected by metadata. For example, if a quality metric indicates that the coding quality of a portion of the bitstream is relatively poor, then the preprocessor can blur the sequence in an effort to mask the sub-par quality. As another example, the preprocessor may be used to detect artifacts in the recovered video (as described above); if artifacts are detected and the metadata M1 indicates that the exposure of the frame(s) is in flux or varies beyond a predetermined threshold, then the preprocessor may introduce noise into the frame(s).

Coding system 800 may include a postprocessor (not shown), and certain postprocessing operations may be affected by metadata, including metadata M3 generated by the first encoder 820.

It will be appreciated that many of the types of metadata that may comprise the metadata M3 discussed above generally are discarded after the first encoding process has been completed, and therefore usually are not available to supplement decisions made by a transcoder. It also will be appreciated that having these types of metadata may be especially beneficial when the video processing environment is constrained in some manner, such as within a mobile device (e.g., a mobile phone, netbook, etc.). With regard to a mobile device, there may be limited storage space on the device such that the source video may be compressed into a first bitstream in real-time, as it is being captured and the source video is discarded immediately after processing. In this case, the transcoder may not have access to the source video but may access the metadata to transcode the coded video data with higher quality than may be possible if transcoding the coded video data alone. A mobile device also may be limited in processing and/or battery power such that multiple start-from-scratch encodes of a video sequence (which may occur because the user wants to, for example, upload/send the video to various people, services, etc.) would tax the processor to such an extent that the battery would drain too quickly, etc. It also may be the case that the device is constrained by channel limitations. For example, the user of the mobile phone may be in a situation where he needs to upload a video to a particular service, but effectively is prohibited because he's in an area with low-bandwidth Internet connectivity (e.g., an area covered only by EDGE, etc.); in this scenario the user may be able to more quickly re-encode the video (because of the metadata associated with the video) to put it in a form that is more amenable to being uploaded via the “slow” network.

As another example, assume that a mobile phone has generated a first bitstream from a real-time capture, and that the first bitstream has been encoded at VGA resolution using the H.264 video codec, and then stored to memory within the phone, together with various metadata M1 realized during the real-time capture, and any metadata M3 generated by the H.264 coding process. At some later point in time, the user may want to upload or send the first bitstream to a friend or video-sharing service, which may require the first bitstream to be transcoded into a format accepted by the user/service; e.g., the user may wish to send the video to a friend as an MMS (Multimedia Messaging Service) message, which requires that the video be in a specific format and resolution, namely H.263/QCIF.

Assuming the source video was deleted during or after generation of the first bitstream (as a matter of practice or because, for example, the phone does not have enough storage capacity to keep both the source video and the first bitstream), the phone will need to decode the first bitstream in order to generate a recovered video sequence (i.e., some approximation of the original capture) that can be re-encoded in the new format. After the first bitstream (or a first portion of the first bitstream) has been decoded, the transcoder's encoder may begin to encode the recovered video into a second bitstream. The metadata M3 provided to the encoder's rate controller may include, for example, information indicating the relative complexity of the current or future frames, which may be used by the rate controller to, for example, assign a low quantization parameter to a frame that is particularly complex.

The various systems described herein may each include a storage component for storing machine-readable instructions for performing the various processes as described and illustrated. The storage component may be any type of machine-readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer-readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention. For example, in an embodiment, metadata M3 (as described with respect to FIGS. 8 and 9) can be generated by the encoder 120 and/or the encoder 140 (as described with respect to FIG. 1), and can be transmitted to the transcoder 850 (as described with respect to FIG. 8).

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

We claim:

1. A coding method, comprising:
decoding a stored sequence of first coded video data to generate recovered video data therefrom, the first coded video data having been generated according to a first video coding protocol; and
coding the recovered video data into second coded video data according to a second video coding protocol,
wherein, during the coding of the second coded video data, one or more coding parameters are selected based on metadata representing one or more conditions during capture of a source video from which the first coded video data was generated.

2. The method of claim 1 wherein the metadata comprises information associated with an image sensor processor, the image sensor processor being part of an image-capture system that captured the source video.

3. The method of claim 1 wherein the metadata indicates physical movement of an image-capture system that captured the source video.

4. The method of claim 1 wherein the metadata further includes information generated during coding of the source video, wherein the information relates to coding decisions made therein.

5. The method of claim 4 wherein the metadata includes candidate pixel block coding types available during coding of the source video.

6. The method of claim 4 wherein the metadata includes identification of frames from the source video that were candidate reference frames during coding of the source video.

7. The method of claim 4 wherein the metadata includes a quality metric that indicates the quality of a portion of the first coded video data.

8. The method of claim 7 wherein the metadata includes a first coding parameter used to code a portion of the source video into a portion of the first coded video data,
the method further comprising, based on the quality metric, determining whether to re-use the first coding parameter during coding of the respective portion of the recovered video data.

9. The method of claim 4 wherein the metadata includes quantization parameters associated with a portion of the first coded video data.

10. The method of claim 9 wherein the metadata includes noise estimates associated with a portion of the first coded video data,
the method further comprising, if the quantization parameters are above a predetermined threshold, selecting coding parameters based on the noise estimates during coding of the recovered video data.

11. The method of claim 9 wherein the metadata includes information related to the physical motion of an image-capture system that captured a portion of the source video,
the method further comprising determining whether to re-use the quantization parameters during coding of a portion of the recovered video data based on whether:
the quantization parameters are above a first predetermined threshold; and
the physical motion is above a second predetermined threshold.

12. The method of claim 9 wherein the metadata includes information related to the fullness of a transmission buffer during coding of a portion of the source video,
the method further comprising determining whether to re-use the quantization parameters during coding of a portion of the recovered video data based on whether:
the quantization parameters are above a first predetermined threshold; and
the fullness of the transmission buffer is above a second predetermined threshold.

13. The method of claim 1 further comprising, prior to coding the recovered video data into second coded video data, generating preprocessed video data from the recovered video data.

14. The method of claim 13 wherein the metadata includes exposure information that indicates that, over a portion of the source video, the exposure varies beyond a predetermined threshold,
the method further comprising:
searching for artifacts in the respective portion of the recovered video data; and
if artifacts are found in the respective portion of the recovered video data, introducing noise into the respective portion of the recovered video data.

15. The method of claim 4 further comprising, prior to coding the recovered video data into second coded video data, generating preprocessed video data from the recovered video data.

16. The method of claim 15 wherein the metadata includes a quality metric that indicates the quality of a portion of the first coded video data,
the method further comprising introducing noise into the respective portion of the recovered video data if the quality metric indicates that the quality of the respective portion of the first coded video data is below a predetermined threshold.

17. A system, comprising:
a decoder to decode a sequence of first coded video data to generate recovered video data, the first coded video data having been generated according to a first video coding protocol;
an encoder to code the recovered video data into second coded video data according to a second video coding protocol; and
a rate controller to select one or more coding parameters based on metadata representing one or more conditions during capture of a source video from which the first coded video data was generated.

18. The system of claim 17 wherein the metadata further includes information generated during coding of the source video, wherein the information relates to coding decisions made therein.

19. The system of claim 17 wherein the rate controller comprises a metadata processor to analyze the metadata.

20. The system of claim 17 wherein the system further comprises a confidence estimator to manage the rate controller's reliance on the metadata.

21. The system of claim 20 wherein decisions made by the confidence estimator are based on the metadata.

22. The system of claim 17 wherein the metadata comprises information associated with an image sensor processor, the image sensor processor being part of an image-capture system that captured the source video.

23. The system of claim 17 wherein the metadata indicates physical movement of an image-capture system that captured the source video.

24. The system of claim 17 further comprising a preprocessor to generate preprocessed video data from the recovered video data.

25. A computer-readable medium encoded with a set of instructions which, when performed by a computer, perform a method comprising:
decoding a stored sequence of first coded video data to generate recovered video data therefrom, the first coded video data having been generated according to a first video coding protocol; and
coding the recovered video data into second coded video data according to a second video coding protocol,
wherein, during the coding of the second coded video data, one or more coding parameters are selected based on metadata representing one or more conditions during capture of a source video from which the first coded video data was generated.

26. The computer-readable medium of claim 25 wherein the metadata comprises information associated with an image sensor processor, the image sensor processor being part of an image-capture system that captured the source video.

27. The computer-readable medium of claim 25 wherein the metadata indicates physical movement of an image-capture system that captured the source video.

28. The computer-readable medium of claim 25 wherein the metadata further includes information generated during coding of the source video, wherein the information relates to coding decisions made therein.

29. The computer-readable medium of claim 28 wherein the metadata includes a quality metric that indicates the quality of a portion of the first coded video data.

30. The computer-readable medium of claim 28 wherein the metadata includes:
information related to the physical motion of an image-capture system that captured a portion of the source video; and
quantization parameters associated with a portion of the first coded video data,
and wherein the method further comprises determining whether to re-use the quantization parameters during coding of a portion of the recovered video data based on whether:
the quantization parameters are above a first predetermined threshold; and
the physical motion is above a second predetermined threshold.
